(19) United States
(12) Patent Application Publication
(10) Pub. No.: US 2013/0150463 A1
(43) Pub. Date: Jun. 13, 2013

(54) PARTICULATE WATER-SOLUBLE POLYMERIC POLYOL TREATED WITH TRIALKYL ORTHOESTERS OR TETRAALKYL ORTHOCARBONATES

(71) Applicants: Meinolf Brackhagen, Walsrode (DE); Charles B. Mallon, Hillsborough, NJ (US); Emmett M. Partain, Bound Brook, NJ (US); Hans-Peter Schneider, Stade (DE); Eric P. Wasserman, Hopewell, NJ (US)

(72) Inventors: Meinolf Brackhagen, Walsrode (DE); Charles B. Mallon, Hillsborough, NJ (US); Emmett M. Partain, Bound Brook, NJ (US); Hans-Peter Schneider, Stade (DE); Eric P. Wasserman, Hopewell, NJ (US)

(73) Assignee: DOW GLOBAL TECHNOLOGIES LLC, Midland, MI (US)

(21) Appl. No.: 13/700,265

(22) PCT Filed: Jun. 8, 2010
(86) PCT No.: PCT/IB2010/001377

§ 371 Date: Dec. 18, 2012

(51) Int. Cl. C08B 3/06

(52) U.S. Cl. CPC C08B 3/06
USPC 514/781; 536/69; 106/501.1; 510/405; 426/519

(57) ABSTRACT

The present invention relates to a particulate water-soluble polymeric polyol that is treated with a compound represented by formula (I), CR¹_{χ}(OR²)₄₋ₓ (I) wherein R¹ is selected from hydrogen, a C₁-C₂₀ alkyl group and an aryl group, R² is independently at each occurrence selected from a C₁-C₂₀ alkyl group and an aryl group, and x is selected from the integer 0 and 1; or with a combination of said compounds, to a method for treating a particulate water-soluble polymeric polyol with the above compound and to a method for the preparation of an aqueous solution of the treated particulate water-soluble polymeric polyol.

The present invention relates to a particulate water-soluble polymeric polyol that is treated to retard dissolution of the polymeric polyol in an aqueous system, to a method for treating the particulate water-soluble polymeric polyol, to the use of certain orthocarbonates or orthoesters as will be described below for crosslinking of a particulate water-soluble polymeric polyol whereby this crosslinking is hydrolytically reversible at a pH of less than 7. Furthermore, the present invention relates to a method for preparation of an aqueous solution of the treated particulate water-soluble polymeric polyol of the present invention.

### BACKGROUND OF THE INVENTION

Some water-soluble polymers such as cellulose ethers are difficult to dissolve in water due to the fact that the first particles that come into contact with water immediately swell and stick to each other, forming a gel-like barrier that shields the remaining polymers from hydration. These water-soluble polymers are conveniently supplied as a particulate dry material that is then dissolved in water for the desired end use of such water-soluble polymers. The above-described gel-blocking behavior of water-soluble polymers is a considerable drawback for those applications of water-soluble polymers that comprise the solution of the particulate water-soluble polymer such as cellulose ethers in aqueous systems.

One approach used in industry to overcome this problem, if permissible in the end-use application, is to apply glyoxal to the cellulose ether to form a hydrolytically-unstable network. The crosslinking of the cellulose ether with glyoxal is therefore reversible in aqueous medium and thus treated cellulose ether can be suspended in aqueous medium and ultimately dissolved when the crosslinked network formed with glyoxal is hydrolytically cleaved. The drawback of this method is that glyoxal is considered as a toxic compound and is regenerated upon hydrolysis of the crosslinked network. Thus, alternatives avoiding the above-described gel-blocking behavior are desired.

U.S. Pat. No. 3,362,847 discloses a process for improving the water-dispersibility of water-soluble cellulose ether by treating the surface of the particulate cellulose ether with a combination of a water-soluble polybasic organic carboxylic acid having from 2 to 10 carbon atoms and a water-soluble organic polyamine having at least two primary amino groups. Preferably, the polybasic acid and amine are applied to the cellulose ether by dissolving the polybasic organic carboxylic acid and the water-soluble organic polyamine in a solvent, which is a non-solvent for the cellulose ether, and suspending the cellulose ether in such treating solution.

U.S. Pat. No. 3,461,115 relates to a process for the preparation of a macromolecular compound containing hydroxyl groups, which is soluble in water without forming lumps. This process comprises treating the water-soluble macromolecular compound in the solid state with 0.5 to 5% by weight of an aliphatic dicarboxylic acid containing 2 to 8 carbon atoms, or a salt or an ester thereof.

US 2005/0143572 relates to a method for the production of cellulose ethers whereby the cellulose ethers having free hydroxyl groups are reacted with dicarboxylic and/or polycarboxylic acids and a nitrogen-containing compound. The process comprises intensively mixing essentially dry, pulverulent cellulose ether with a mixture of organic bifunctional and/or polyfunctional acid and nitrogen-containing compound in a non-nucleophilic organic solvent prior to reacting the cellulose ether to provide the modified cellulose ether, which can be stirred into water at a pH greater than or equal to 11 without agglutination.

The object of the present invention is thus to provide a treated particulate water-soluble polymeric polyol that shows retarded dissolution in an aqueous system to avoid the problems discussed above with respect to dissolution of water-soluble polymers. Another object of the present invention is to find a suitable treating agent that results in reversible crosslinking of the particulate water-soluble polymeric polyol in order to control dissolution of the reversibly crosslinked polymeric polyol in aqueous system. It is particularly desirable that this reversible crosslinking is pH dependent with the result that the dissolution can be controlled by adjustment of pH. It is a further object of the present invention to provide such a treated particulate polymeric polyol whereby the by-products formed upon dissolution of the treated polymeric polyol in aqueous systems are not harmful and preferably physiologically acceptable.

### SUMMARY OF THE INVENTION

This and other objects, as will be discussed below, have been attained by a particulate water-soluble polymeric polyol that is treated with a compound represent by formula I

CR¹ₓ(OR²)₄₋ₓ (I)

wherein
R¹ is selected from hydrogen, a C₁-C₂₀ alkyl group and an aryl group,
R² is independently at each occurrence selected from a C₁-C₂₀ alkyl group and an aryl group, and
x is selected from the integer 0 and 1; or
with a combination of said compounds.

According to another aspect the present invention relates to a method for treating a particulate water-soluble polymeric polyol comprising:

contacting the particulate water-soluble polymeric polyol with a liquid phase comprising
a) a solvent component comprising at least one organic solvent free of primary hydroxyl groups, the water-soluble polymeric polyol being insoluble in the solvent component;
b) a compound represented by formula (I),

CR¹ₓ(OR²)₄₋ₓ (I)

wherein
R¹ is selected from hydrogen, a C₁-C₂₀ alkyl group and an aryl group,
R² is independently at each occurrence selected from a C₁-C₂₀ alkyl group and an aryl group, and
x is selected from the integer 0 and 1;
or a combination of said compounds; and
c) optionally a catalyst; and
   recovering the surface treated particulate water-soluble polymeric polyol.

A further aspect of the present invention relates to the use of a compound represented by formula (I),

CR¹ₓ(OR²)₄₋ₓ (I)
wherein
   R¹ is selected from hydrogen, a C₁-C₂₀ alkyl group and an aryl group,
   R² is independently at each occasion selected from a C₁-C₂₀ alkyl group and an aryl group, and

x is selected from the integer 0 and 1

for at a pH of less than 7 hydrolytically reversible crosslinking of a particulate water-soluble polymeric polyol.

Furthermore, the present invention relates to a method for the preparation of an aqueous solution of the treated particulate water-soluble polymeric polyol as defined above comprising:
a) dispersing the treated particulate polymeric polyol in an aqueous liquid to form a dispersion having a pH of 7-14;
b) adjusting the pH of the dispersion to 2-6 by the addition of an acid to increase the dissolution rate of the treated particulate polymeric polyol; and
c) agitating the dispersion until the polymer particles are fully dissolved.

The present inventors have surprisingly found that orthocarbonates and orthoesters as described by formula I above can be used to reversibly crosslink a particulate water-soluble polymeric polyol thereby controlling the dissolution behavior in aqueous systems of particulate water-soluble polymeric polyols treated with such orthocarbonates or orthoesters. The present inventors discovered that the crosslinking of the particulate polymeric polyols with the orthocarbonates and orthoesters according to the present invention is hydrolytically reversible. The hydrolytic cleavage of the crosslinking is pH-dependent with the result that dissolution of the treated particulate polymeric polyol according to the present invention in aqueous systems can be controlled by adjustment of pH. Furthermore, the orthoesters and orthocarbonates according to the present invention and their reaction products with the polymeric polyol upon hydrolysis decompose to essentially harmless compounds. By contrast, dissolution of a glyoxal-treated polymer in water releases glyoxal. The behavior of the crosslinked polymers of the present invention is also advantageous compared to the carboxylic acid cross-linkers as known from the prior art as discussed above since the reversible crosslinking with polymeric polycarboxylic acids known from the prior art will result in the liberation of the polycarboxylic acid itself. In contrast thereto the orthocarbonates or orthoethers will liberate on dissolution of the thus treated polymer polyols carbon dioxide or monocarboxylic acids.

### DETAILED DESCRIPTION OF THE INVENTION

According to the broadest aspect of the present invention a particulate water-soluble polymeric polyol is treated with a compound represented by formula I

CR¹ₓ(OR²)₄₋ₓ (I)

wherein
R¹ is selected from hydrogen, a C₁-C₂₀ alkyl group and an aryl group,
R² is independently at each occurrence selected from a C₁-C₂₀ alkyl group and an aryl group preferably a C₆-C₁₈ aryl group, and
x is selected from the integer 0 and 1; or
   with a combination of said compounds.

The water-soluble polymeric polyol may have a solubility in water of at least 1 g, more preferably at least 3 g, most preferably at least 5 g in 100 g of distilled water at 25° C. and 101325 Pa (1 atm).

The water-soluble polymeric polyol is preferably selected from one or more polysaccharides, homo- and copolymers comprising in polymerized form an unsaturated alcohol such as 2-hydroxyethyl acrylate or a vinylalcohol.

The water-soluble polymeric polyol generally has a weight average molecular weight of at least 10,000, preferably at least 12,000, more preferably at least 15,000, most preferably at least 18,000. The preferred upper limit for the weight average molecular weight largely depends on the type of polymer. Generally the weight average molecular weight of the water-soluble polymer is up to 10,000,000, preferably up to 8,000,000, more preferably up to 5,000,000. The weight average molecular weight is determined by light scattering according to the Standard Test Method ASTM D-4001-93 (2006).

The hydroxyl groups of the polymer are suitably secondary or primary alcohol groups whereby primary alcohol groups are particularly preferred. Thus the polymer chains of one class of suitable particulate water-soluble polymeric polyols to be used according to the present invention bear hydroxyalkyl groups, preferably hydroxyethyl or hydroxypropyl groups whereby a 3-hydroxypropyl group is more preferred compared to a 2-hydroxypropyl group.

One preferred type of water-soluble polymer a) is a polysaccharide. Examples of polysaccharides include gum arabic, xanthan gum, gum karaya, gum tragacanth, gum ghatti, carrageenan, dextran, alginates, agar, gellan gum, gallactomannans such as guar gum, pectins, starches, starch derivatives, guar derivatives, xanthan derivatives, and cellulose derivatives. Starch derivatives, guar derivatives and xanthan derivatives are described in more detail in European patent EP 0 504 870 B, page 3, lines 25-56 and page 4, lines 1-30. Useful starch derivatives are for example starch ethers, such as hydroxypropyl starch or carboxymethyl starch. Useful guar derivatives are for example carboxymethyl guar, hydroxypropyl guar, carboxymethyl hydroxypropyl guar or cationized guar. Preferred hydroxypropyl guars and the production thereof are described in U.S. Pat. No. 4,645,812, columns 4-6. Preferred polysaccharides are cellulose esters or cellulose ethers. Preferred cellulose ethers are carboxy-C₁-C₃-alkyl celluloses, such as carboxymethyl celluloses; carboxy-C₁-C₃-alkyl hydroxy-C₁-C₃-alkyl celluloses, such as carboxymethyl hydroxyethyl celluloses; C₁-C₃-alkyl celluloses, such as methylcelluloses; C₁-C₃-alkyl hydroxy-C₁₋₃-alkyl celluloses, such as hydroxyethyl methylcelluloses, hydroxypropyl methylcelluloses or ethyl hydroxyethyl celluloses; hydroxy-C₁₋₃-alkyl celluloses, such as hydroxyethyl celluloses or hydroxypropyl celluloses; mixed hydroxy-C₁-C₃-alkyl celluloses, such as hydroxyethyl hydroxypropyl celluloses, or alkoxy hydroxyethyl hydroxypropyl celluloses, the alkoxy group being straight-chain or branched and containing 2 to 8 carbon atoms. Most preferably, the composition comprises a water-soluble cellulose ether, such as a methylcellulose with a degree of methyl substitution DS_{methoxyl} of from 1.2 to 2.2, preferably from 1.5 to 2.0, or a hydroxypropyl methylcellulose with a DS_{methoxyl} of from 0.9 to 2.2, preferably from 1.1 to 2.0 and a MS_{hydroxypropoxyl} of from 0.02 to 2.0, preferably from 0.1 to 1.2. Generally the weight average molecular weight of the polysaccharide is up to 20,000,000, preferably up to 5,000,000, more preferably up to 1,000,000.

More preferably, the water-soluble polymer is an above-described cellulose ether. Most preferably, the water-soluble polymer is hydroxyethyl cellulose, cationic hydroxyethyl cellulose, hydroxypropyl methyl cellulose, or methyl cellulose.

One advantage of the process of the present invention is that due to be insolubility of the water-soluble hydroxyl-functional polymer in the solvent mixture relatively high concentrations of a polymer in the liquid phase can be used in the method according to the present invention. Water-soluble hydroxyl-functional polymers, especially cellulose ethers substantially increase the viscosity of the solution even at very low concentrations. Since according to the present invention the solvent mixture is selected to avoid an appreciable dissolution of the polymer in the liquid phase the substantial increase of the viscosity can be avoided even at very high concentration of the hydroxyl-functional water-soluble polymer. Thus the method of the present invention can still be run efficiently at an amount of particulate water-soluble hydroxyl-functional polymer of as high as 50 weight % based on the total weight of the liquid phase. Suitable upper limits for the amount of the polymer are 45 weight %, 35 weight %, 30 weight %, 25 weight %, or 20 weight % of polymer based on the total weight of the liquid phase. Suitable lower limits for the amount of water-soluble hydroxyl-functional polymer are 1 weight %, 5 weight %, 7 weight %, 10 weight % or 15 weight % based on the total weight of the liquid phase Because this reaction is most efficiently conducted at relatively high solids contents (>5%), the dissolution of a substantial fraction of the polymer starting material would render the mixture extremely viscous and difficult to agitate and convey. Thus the organic/water mixture in which the polymer is suspended should not allow more than about 10, no more than 9, no more than 8, no more than 7, no more than 6, no more than 5, no more than 4, no more than 3, no more than 2, or no more than 1 wt.-% of the polymer to dissolve. It is preferred that the solvent mixture does not cause the particles to fuse into a mass if agitation ceases for up to 15 minutes.

The orthocarbonate or orthoester compounds according to the present invention represented by formula I are preferably non-cyclic. In preferred orthocarbonates or orthoesters according to the present invention substituent R¹ is selected from hydrogen and linear C₁ to C₄ alkyl and substituent R² is selected from linear C₁ to C₄ alkyl; particularly preferred orthocarbonates or/and orthoesters to be used according to the present invention may be selected from tetraethyl orthocarbonate, trimethyl orthoacetate and triethyl orthoacetate.

The orthocarbonates and orthoesters according to the present invention can be applied in a wide range of amounts relative to the weight of the particulate water-soluble polymeric polyol. A suitable lower limit for the amount of orthocarbonates or orthoesters according to the present invention is 10 wppm or 100 wppm, or 300 wppm, or 500 wppm, or 1,000 wppm, or 1,500 wppm, or 2,000 wppm based on the total weight of polymeric polyol. Suitable upper limits for the amount of orthocarbonates or orthoesters to be employed according to the present invention are 200,000 wppm, or 150,000 wppm, or 75,000 wppm, or 70,000 wppm, or 65,000 wppm, or 60,000 wppm based on the total amount of polymeric polyol.

The treated particulate polymeric polyol according to the present invention is prepared by contacting the particulate water-soluble polymeric polyol with a liquid phase comprising:
a) a solvent component comprising an organic solvent free of primary hydroxyl groups whereby the water-soluble polymer polyol is insoluble in that solvent component and
b) the compound represented by formula I as defined above.

The organic solvent for the solvent component may be selected from a wide range of suitable solvents whereby primary alcohols and water should be avoided since primary alcohols may result in unwanted side reactions. Suitable solvents according to the present invention are non-polar solvents like aliphatic or aromatic hydrocarbons, polar aprotic solvents like ketones, N,N-dialkylamides and ethers as well as secondary and tertiary alcohols or mixtures thereof. The solvent component according to the process of the present invention may even comprise limited amounts of water as long as the requirement is fulfilled that the particulate polymeric polyol does not appreciable dissolve in the solvent component. The water may form with the at least one organic solvent either a homogeneous or a heterogeneous mixture.

The liquid phase for contacting the particulate water-soluble polymeric polyol according to the present invention may optionally comprise a catalyst to promote reaction between orthocarbonate or orthoester according to the present invention with the hydroxyl groups of the polymeric polyol. Suitable catalysts are Brønsted acids having a pkₐ of less than 6. Particularly suitable are imidazole hydrochloride or imidazolium acetate.

According to one embodiment of the method according of the present invention the particulate water-soluble polymeric polyol is suspended in the liquid phase. The suspension is stirred for a sufficient period of time to achieve the desired degree of crosslinking. One advantage of using the method of the present invention is that a wide temperature range, also including relatively low temperatures, can be employed for treating the particulate water-soluble polymeric polyol. A suitable temperature range is from −30° C. to 100° C., preferably 15 to 55° C., more preferred 15 to 30° C. Preferably the reaction can be performed under ambient conditions. A suitable reaction time can be between several minutes and several hours, for example from 5 min to 5 h, or from 10 min to 4 h, or from 20 min to 3 h, or from 30 min to 2 h. Of course, the selected temperature will also depend on the physical properties of the solvent component, especially freezing point and boiling point of the solvent component. Especially the temperature is to be selected to maintain the solvent component in the liquid phase.

After the appropriate reaction time the treated particulate polymeric polyol is separated from the liquid phase whereby any appropriate solid-liquid separation methods known to a person skilled in the art can be used. Suitable methods are filtration, sedimentation, centrifugation or evaporation of the solvent. The separated particulate water-soluble polymeric polyol may optionally be washed and dried to obtain the final product.

According to an alternative method the particulate polymeric polyol according to the present invention may be agitated using for example a high-shear mixer like a ploughshare mixer or a fluidized bed and the reagent solution, comprising the orthocarbonate or orthoester according to the present invention, optionally an appropriate solvent as described above, and optionally a catalyst as described above, is sprayed onto the polymeric polyol particles. The thus treated particles may then be dried at elevated or ambient temperature to recover the treated particulate polymeric polyol according to the present invention.

Due to the pH-dependency of the hydrolysis reaction that cleaves the crosslinks the treated particulate polymeric polyol according to the present invention can be easily suspended in an aqueous phase having a pH of 7 to 14. Since at this pH the hydrolysis of the crosslinks is rather slow the particulate polymeric polyol can be suspended in the aqueous phase before the polymer starts to dissolve or swell thereby avoiding the initially described problems of gel-formation and gel-blocking during the dissolution process. After obtaining a homogeneous dispersion of the treated polymeric polyol according to the present invention the pH of the dispersion can be lowered to a range of pH 2 to 6 in order to promote dissolution of the polymeric polyol in the aqueous phase. The dispersion can be stirred until the polymeric polyol particles are completely dissolved.

According to one embodiment of the present invention the treated particulate water-soluble polymeric polyol is suspended in a non-buffered aqueous phase in order to allow pH adjustment to the desired range with relatively small amounts of acid.

The treated particulate polymeric polyols according to the present invention can be used in a variety of commercial applications. For example water-soluble cellulose ethers can be used in latex paints, construction applications, cosmetics, household cleaners, oilfield applications, pharmaceuticals, personal care product or foods. The treated particulate polymeric polyols according to the present invention can be advantageously employed in applications where the dissolution rate and the build-up of viscosity in aqueous systems due to the dissolution of the polymeric polyol should be controlled for example for handling purposes. For instance in the production of latex paints it is highly desirable to slurry cellulose ethers in water but delay the dissolution of the cellulose ether for an extended time such as 20 min so that the viscosity of the initial slurry is low enough to be pumped from storage tanks to formulation tanks even through narrow pipes.

The present invention will now be described in more details with reference to the following examples.

### Example 1

A 20 g sample of hydroxyethylcellulose containing an ethylene oxide molar substitution level (EOMS) of 3.58 was slurried for 1 h at room temperature with 200 ml of acetone, 1 ml of trimethyl orthoacetate (purchased from Acros Organics at 96 to 99% purity and used as received), 0.1 ml of acetic acid, and 47 mg of imidazole. The slurry was then filtered, washed with 100 ml of acetone, and dried in a vacuum oven overnight at 50-55° C.

In a hydration time test at pH=8.0, this material exhibited 5 units of relative viscosity after 10 min and 10 units of relative viscosity after 60 min.

In a hydration time test at pH=7.2, this material exhibited 10 units of relative viscosity after 10 min and 390 units of relative viscosity after 40 min.

In a hydration time test at pH=6.0, this material exhibited 15 units of relative viscosity after 1 min and 465 units of relative viscosity after 40 min.

In a hydration time test at pH=4.0, this material exhibited 10 units of relative viscosity after 1 min and 465 units of relative viscosity after 10 min.

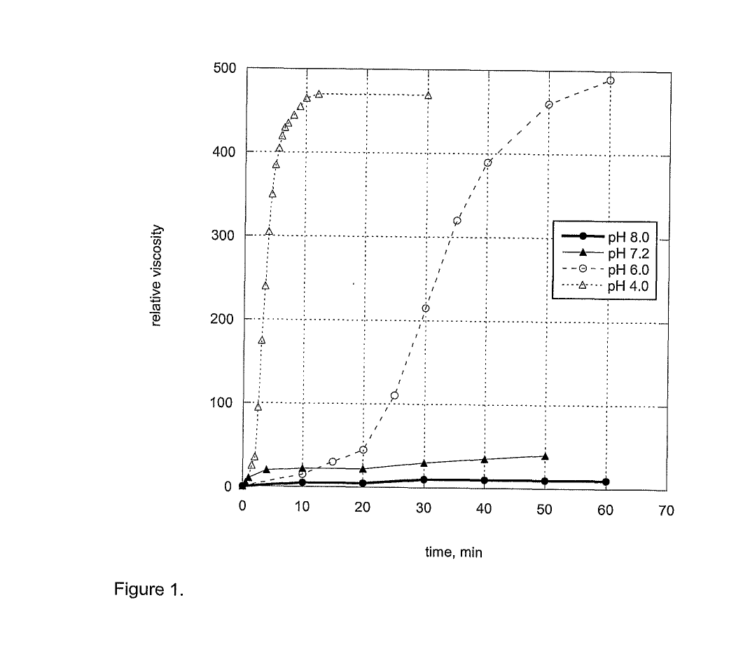

The effect of the pH on the rate of dissolution of the treated hydroxyethylcellulose is summarized in FIG. 1

### Example 2

The process of Example 1 was repeated except no acetic acid or imidazole was added.

In a hydration time test at pH=7.2, this material exhibited 10 units of relative viscosity after 4 min and 30 units of relative viscosity after 40 min.

In a hydration time test at pH=6.0, this material exhibited 5 units of relative viscosity after 5 min and 480 units of relative viscosity after 30 min.

### Comparative Example 1

The process of Example 1 was repeated except no trimethyl orthoacetate, acetic acid or imidazole was added.

In a hydration time test at pH=7.2, this material exhibited 8 units of relative viscosity after 1 min and 530 units of relative viscosity after 40 min.

In a hydration time test at pH=8.0, this material formed lumps and did not give a smooth viscosity curve.

### Comparative Example 2

The process of Example 1 was repeated except no trimethyl orthoacetate was added.

In a hydration time test at pH=7.2, this material exhibited 5 units of relative viscosity after 1 min and 510 units of relative viscosity after 40 min.

All hydration time determinations employed a Brabender viscometer with bath temperature of 25° C. using a procedure as follows:

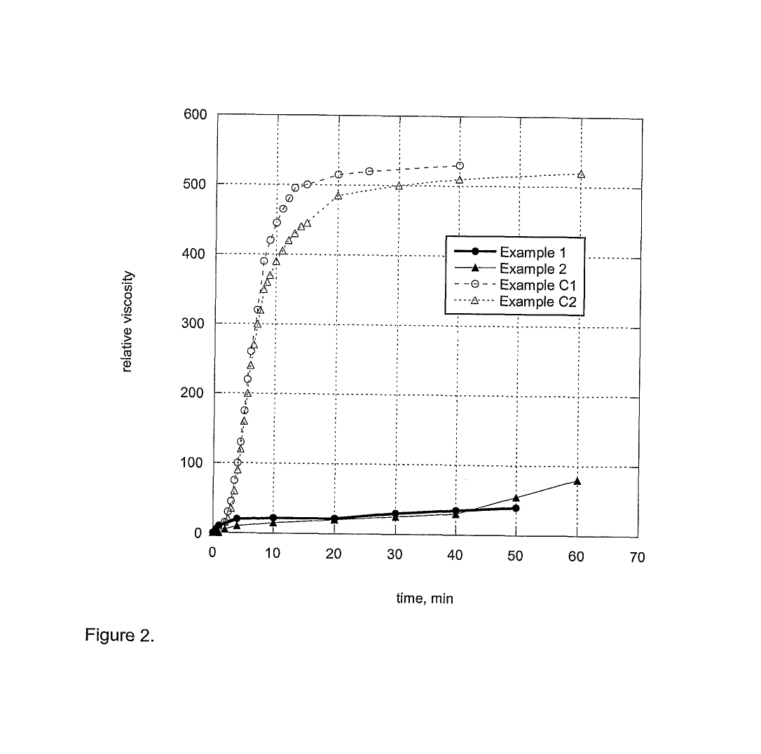

A comparison of dissolution profiles in pH 7.2 buffer solution for the materials made in Examples 1, 2 comparative example 1 and comparative example 2. is shown in FIG. 2.

### Equipment

Brabender Visco-Corder® Model VC-3/A, fully recording, stepless variable SCR speed control, with rpm display up to 200 rpm, 115 VAC, 60 Hz (Brabender Instruments Inc., South Hackensack, N.J., USA), equipped with a stainless steel sensor paddle of 4.125″ (10.5 cm) total length, having two vertical rectangular wings of 1″ (2.5 cm) width and 1.625″ (4 cm) height, a jacketed sample bowl for use with heat transfer coil assembly, a 250 ml stainless steel beaker, a circulating water bath and a pH meter with standard calomel reference electrode and pH electrode.

### Procedure:

The stainless steel beaker is centered in the jacketed sample bowl. The space between the jacketed sample bowl and beaker is filled with water. The beaker is charged with 200 ml of solvent (either distilled water or any buffered aqueous solution, as the case may be). The viscometer is turned on and the paddle is allowed to stir the solvent at 200 rpm. The solvent is allowed to equilibrate at 25.0±0.2° C. A pre-weighed sample of the polymer is added to the solvent while stirring. The polymer is added slowly to avoid lumping, but in less than one minute. The chart recorder is turned on when the polymer is added (time=0). The viscometer is allowed to run until the viscosity deflection reaches a constant value (Cₘₐₓ).

1. A particulate water-soluble polymeric polyol that is treated with a compound represented by formula (I),
CR¹ₓ(OR²)₄₋ₓ (I)
wherein
R¹ is selected from hydrogen, a C₁-C₂₀ alkyl group and an aryl group,
R² is independently at each occurrence selected from a C₁-C₂₀ alkyl group and an aryl group, and
x is selected from the integer 0 and 1; or
with a combination of said compounds.

2. The particulate water-soluble polymeric polyol of claim 1 wherein the water-soluble polymeric polyol is selected from cellulose ethers, cellulose esters, starch ethers, starch esters, modified starches, vegetable gums, alginates, poly(vinyl alcohol)s, partially etherified poly(vinyl alcohol)s, partially esterified poly(vinyl alcohol)s, acrylic polyols, polyester polyols, polyurethane polyols, polyether polyols or combinations thereof.

3. The particulate water-soluble polymeric polyol of claim 1, wherein the polymeric polyol comprises a plurality of hydroxyalkyl groups.

4. The particulate water-soluble polymeric polyol of claim 1, wherein the polymeric polyol is selected from hydroxyalkyl cellulose ethers and alkyl hydroxyalkyl cellulose ethers.

5. The particulate water-soluble polymeric polyol of claim 1, wherein the compound represented by formula (I) is non-cyclic.

6. The particulate water-soluble polymeric polyol of claim 1, wherein in the compound represented by formula (I) R¹ is selected from hydrogen and linear C₁-C₄-alkyl and R² is selected from linear C₁-C₄-alkyl.

7. The particulate water-soluble polymeric polyol of claim 1 wherein the particulate water-soluble polymeric polyol is surface-treated with 10 to 200,000 wppm of compound represented by formula (I) based on the total weight of polymeric polyol.

8. A method for treating a particulate water-soluble polymeric polyol comprising:
contacting the particulate water-soluble polymeric polyol with a liquid phase comprising
a) a solvent component comprising at least one organic solvent free of primary hydroxyl groups, the water-soluble polymeric polyol being insoluble in the solvent component;
b) a compound represented by formula (I),
CR¹ₓ(OR²)₄₋ₓ (I)
wherein
R¹ is selected from hydrogen, a C₁-C₂₀ alkyl group and an aryl group,
R² is independently at each occurrence selected from a C₁-C₂₀ alkyl group and an aryl group, and
x is selected from the integer 0 and 1; or a combination of said compounds; and
recovering the surface treated particulate water-soluble polymeric polyol.

9. The method of claim 8 comprising:
suspending the particulate water-soluble polymeric polyol in the liquid phase; and
separating the surface-treated particulate water-soluble polymeric polyol from the liquid phase.

10. (canceled)

11. The method of claim 8, wherein the liquid phase additionally comprises a catalyst selected from Brønsted acids having a pkₐ of less than 6.

12. The method of claim 8, wherein the organic solvent is selected from aliphatic hydrocarbons, aromatic hydrocarbons, secondary alcohols, tertiary alcohols, ketones, N,N-dialkylamides, ethers and mixtures thereof.

13. The method of claim 8, wherein the contacting step is performed at a temperature of −30° C. to 100° C.

14. (canceled)

15. A method for the preparation of an aqueous solution of the treated particulate water-soluble polymeric polyol of claim 1 comprising:
a) dispersing the treated particulate polymeric polyol in an aqueous liquid to form a dispersion having a pH of 7-14;
b) adjusting the pH of the dispersion to 2-6 by the addition of an acid to increase the dissolution rate of the treated particulate polymeric polyol; and
c) agitating the dispersion until the polymer particles are fully dissolved.

16. The method of claim 8 wherein the liquid phase additionally comprises a catalyst.

17. The method of claim 16 wherein the catalyst is imidazole hydrochloride or imidazolium acetate.

18. The method of claim 8 wherein the method additionally comprises the steps of washing and drying the surface-treated particulate water-soluble polymeric polyol.
